(19) United States
(12) Patent Application Publication
(10) Pub. No.: US 2026/0261449 A1
(43) Pub. Date: Sep. 3, 2026

(54) NETWORK POWER MANAGEMENT

(71) Applicant: Ford Global Technologies, LLC, Dearborn, MI (US)

(72) Inventors: Maeen Mawari, Dearborn, MI (US); Ke Li, Sterling Heights, MI (US); Syed Maqsood Hussaini, Farmington Hills, MI (US); Eric Ramsay Paton, Sylvan Lake, MI (US); Srikanth Nadella, Canton, MI (US)

(73) Assignee: Ford Global Technologies, LLC, Dearborn, MI (US)

(21) Appl. No.: 19/068,071

(22) Filed: Mar. 3, 2025

(51) Int. Cl. H04L 12/40; G07C 5/00; G07C 5/08

(52) U.S. Cl. CPC H04L 12/40039; G07C 5/006; G07C 5/0808; H04L 2012/40273

(57) ABSTRACT

An example system can include a computer including a processor coupled to a memory, the memory storing instructions executable by the processor to transmit a wake-up signal to a primary communications bus based on incoming data from an external source. The instructions can additionally be to initiate a timer based on an absence of a bus traffic sustaining message, and to select a linked computer for a phased transition to a sleep state based on expiration of the timer, wherein the phased transition to the sleep state includes a silent mode prior the transition to the sleep state.

### BACKGROUND

A system such as a vehicle may utilize numerous computerized devices, sensors, components, etc., which may draw primary power from a battery such as a vehicle’s battery when the system (e.g., vehicle) is in an off state or not being operated. In some instances, battery current draw may be significant, which may result in a need to more frequently charge the battery.

### BRIEF DESCRIPTION OF THE DRAWINGS

FIG. 1 shows an example vehicle system.

FIG. 2 shows example components involved in power management of a vehicle network.

FIG. 3 shows an example message flow diagram among electronic control units of a vehicle system.

FIG. 4 is a diagram of an example process flow for network power management.

### DETAILED DESCRIPTION

The present disclosure describes techniques for power management in an example system, such as a vehicle. Although example systems disclosed herein can include computerized electronic control units of a vehicle, techniques described herein can be applicable to other types of systems including various computing modules or controllers, such as manned or unmanned aerial or aircraft systems, shipboard systems, spacecraft, and other systems. In many such systems, certain updates, such as software updates, firmware updates, updates to configuration settings, user profiles, etc., can be performed while the system is not operating, that is, is in a dormant, sleep, or off state. For example, a software update to a vehicle ECU may be performed while a vehicle is parked during late-night or early morning hours so as to be completed prior to an operator initiating vehicle operations.

In a vehicle system, for example, updating an electronic control unit (ECU) can involve the vehicle’s communications bus, which conveys messages among the vehicle’s ECUs, being fully operational until updates to all ECUs are complete. In some instances, a relatively complex vehicle system (e.g., an advanced driver-assistance system or ADAS) may consume as much as 60 minutes or more to complete an update while a less complex vehicle system (e.g., a human-machine interface or HMI) may consume significantly less time, such as five minutes or less. Thus, in such an example, although a vehicle communications bus may convey messages primarily between a gateway ECU, which may receive data from a source external to the vehicle, and the vehicle’s ADAS, other ECUs in the system architecture may remain active. Such activity, in which uninvolved ECUs remain active until an update to a particular ECU has been completed, can represent an inefficient use of vehicle battery power.

As described herein, ECUs can be selectively inactivated (e.g., placed into a low-power or “sleep” state) based on whether the selected ECU has completed an update. Herein, a “sleep” state means a low-power state during which a central processing unit of an ECU is not actively processing tasks while an interface to a communications bus (e.g., controller area network bus or CAN bus, an ethernet bus, a local interconnect network or LIN bus, etc.) can respond to an activation (e.g., wake-up) signal. Accordingly, a first ECU receiving a relatively small software update, firmware update, or another modification to the ECU’s set of executable instructions, can be placed into a sleep state while a second ECU receiving a relatively large software update, for example, can remain active or awakened until the software update to the second ECU has completed.

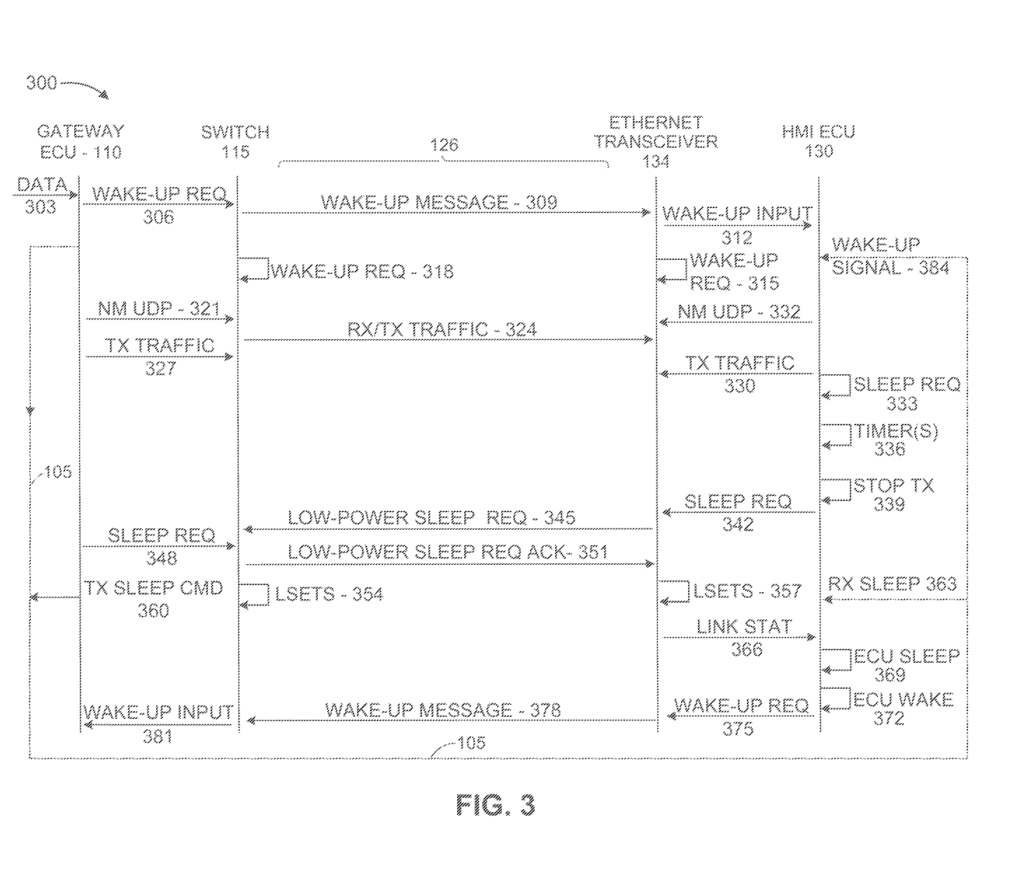

In an example, a gateway ECU, which can receive software updates and other data from an external source, may communicate through a serial peripheral interface to an ethernet communications bus. A gateway ECU can include a plurality of serial peripheral interfaces to a plurality of ethernet communications buses each arranged as point-to-point communication links with a link-partner ECU. In this disclosure, a “link partner” means an electronic control unit that at least sometimes maintains a point-to-point bidirectional communications link with another electronic control unit. For example, in accordance with FIG. 3, HMI ECU 130 can be a link partner with gateway ECU 110. Gateway ECU 110 can sustain bidirectional communications traffic (i.e., send and/or receive data such as in message packets) with a link partner ECU so long as the gateway ECU transmits a network management message utilizing a user datagram protocol. Likewise, a link partner ECU can sustain bidirectional communications traffic with gateway ECU 110 so long as the link partner ECU transmits a network management message via a user datagram protocol.

In an example, based on an absence of a network management message transmitted by either a link partner ECU, the gateway or link partner ECU can enter a silent (e.g., receive exclusively) mode for a specified duration. Based on an expiration of the specified duration, an ethernet communications bus between a gateway ECU and a link partner ECU, the gateway or link partner ECU can transmit a low-power sleep request. Based on a confirmation message from the receiving ECU, the ECU issuing the low-power sleep request can be permitted to enter a sleep state. Accordingly, an ECU can execute a phased transition from an active state to a sleep state in which the ECU first transitions to a silent mode followed by a sleep state. In an example, a low-power sleep request can be in accordance with 1000BASE-T1 physical coding sublayer level operations utilizing an operations, administration, and maintenance (OAM) frame. In such an example, the gateway or link partner ECU can set bit position D4 of symbol 0 to a binary 1 to indicate the low-power sleep request.

In an example, a system can include a computer that includes a processor coupled to a memory, wherein the memory stores instructions executable by the processor to transmit a wake-up signal to a primary communications bus based on incoming data from an external source. The instructions can additionally be to initiate a timer based on an absence of a bus traffic sustaining message. The instructions can additionally be to select a linked computer for a phased transition to a sleep state based on expiration of the timer, wherein the phased transition to the sleep state includes a silent mode prior to the transition to the sleep state.

In an example, the wake-up signal can be triggered in response to incoming data generated by an update manager at the external source.

In an example, the wake-up signal can be triggered in response to a key operation received from a user interface of a vehicle.

In an example, the wake-up signal can be triggered by an analytics component within a vehicle.

In an example, the bus traffic sustaining message can include a user datagram protocol network management message.

In an example, the instructions to initiate the phased transition to the sleep state of the computer can include instructions to transmit a low-power sleep command from the computer to a receiving computer having an interface to the primary communications bus.

In an example, the wake-up signal can be a TC10 wake-up pulse and wherein the primary communications bus can be an ethernet bus.

In an example, the instructions can further include instructions to detect continued activity of the primary communications bus after initiation of the phased transition to the sleep state.

The instructions can additionally include instructions to transmit, via a secondary communications bus, a sleep command to the computer.

In an example, the secondary communications bus can be a controller area network bus.

In an example, the instructions can further include instructions to generate a diagnostic trouble code (DTC) based on the continued activity of the primary communications bus.

In an example, the phased transition to the sleep state of the computer can include a handshake operation wherein the computer and a second computer exchange low-power sleep permissions. The instructions can further include instructions to transmit a second wake-up-signal from the computer during the handshake operation.

In an example, a method can include transmitting, at a first computer having an interface to a primary communications bus, a wake-up signal based on incoming data from an external source. The method can additionally include initiating a timer based on an absence of a bus traffic sustaining message. The method can additionally include selecting a linked computer for a phased transition to a sleep state based on expiration of the timer, wherein the phased transition to the sleep state includes a silent mode prior to the sleep state.

In an example, the wake-up signal can be triggered in response to incoming data generated by an update manager at the external source.

In an example, the wake-up signal can be triggered in response to a key operation received from a user interface of a vehicle.

In an example, the wake-up signal can be triggered by an analytics component within a vehicle.

In an example, the bus traffic sustaining message can include a user datagram protocol network management message.

In an example, initiating the phased transition can additionally include transmitting a low-power sleep command from the first computer to a second computer via the primary communications bus.

In an example, the wake-up signal can be a TC10 wake-up pulse and the primary communications bus can be an ethernet bus.

In an example, the method can additionally include detecting continued activity of the primary communications bus after initiation of the phased transition.

The method can additionally include transmitting, via a secondary communications bus, a command to inactivate the primary communications bus.

In an example, the method can additionally include generating a diagnostic trouble code (DTC) based on the continued activity of the primary communications bus.

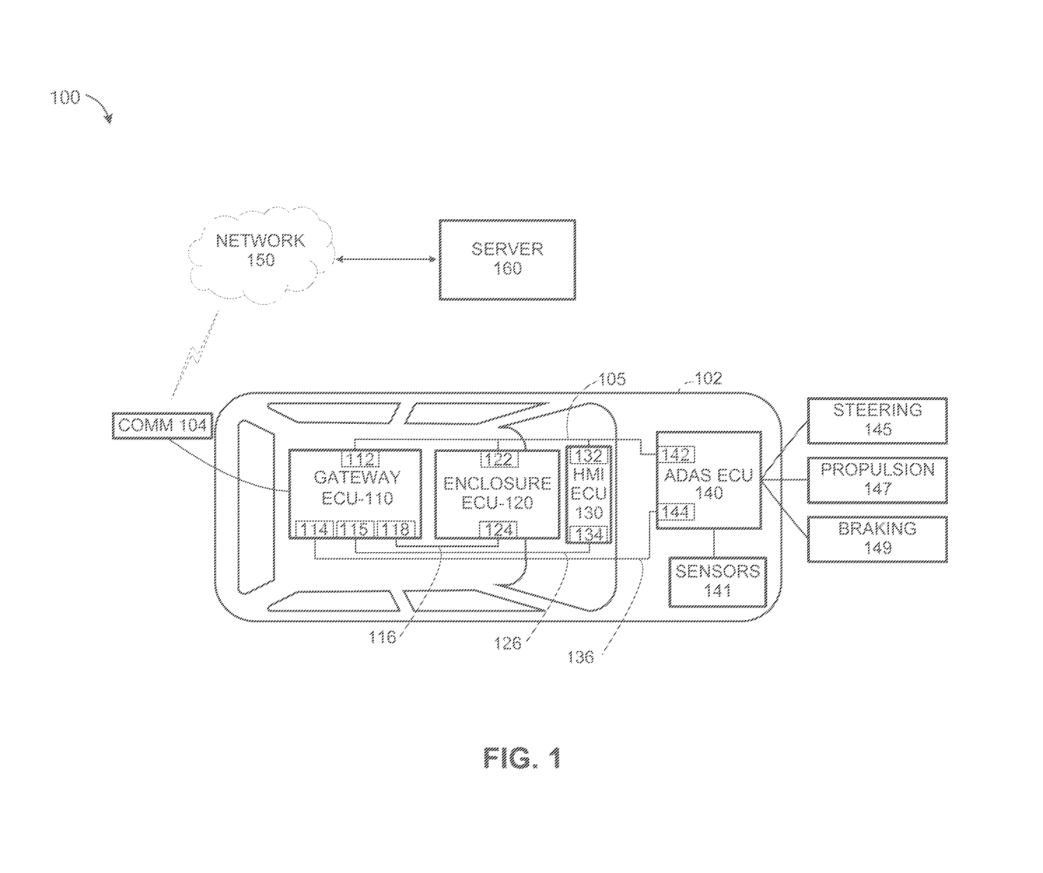

FIG. 1 shows an example vehicle system 100. Vehicle system 100 includes gateway ECU 110, enclosure ECU 120, human-machine interface (HMI) ECU 130, and advanced driving assistance (ADAS) ECU 140, which may be mounted or installed at various locations or structures within vehicle body 102. Gateway ECU 110 can receive and transmit voice and/or data communications to network 150 utilizing communications component 104. In the example of FIG. 1, ECUs 110, 120, 130, and 140 may occasionally receive an update to data such as firmware, software, configuration files, user profiles, etc., stored in a memory accessible to an ECU. In an example, an update may be transmitted from an external source, such as server 160 by way of network 150. In an example, an update can be transmitted while vehicle system 100 is in a non-operational state, such as while vehicle body 102 is parked during late-night or early morning hours so as to be completed prior to an operator initiating vehicle operations.

ADAS ECU 140 can be programmed to receive and process signals representing data output from various externally or internally mounted sensors 141. Accordingly, ADAS ECU 140 can receive signals from externally mounted sensors 141, which may include camera sensors, radar sensors, lidar sensors, acoustic sensors, rain sensors, etc. ADAS ECU 140 may also receive signals from sensors within vehicle body 102, such as internally mounted cameras, wheel speed sensors, steering wheel sensors, engine torque sensors, and so forth. ADAS ECU 140 can provide output signals to steering component 145 (e.g., a steering wheel, a steering rack, etc.,) propulsion component 147, and braking component 149 to provide assisted driving functionality to an operator of vehicle system 100. Assisted driving functionality can include an autonomous driving mode, which can be defined as one in which propulsion, braking, and steering of vehicle body 102 are controlled by ADAS ECU 140. Assisted driving can include a semiautonomous (i.e., assisted) mode, in which ADAS ECU 140 controls one or two of propulsion, braking, and steering of vehicle body 102. Assisted driving can include a nonautonomous mode in which ADAS ECU 140 provides notifications, via HMI ECU 130, while a human operator controls steering, propulsion, and braking of vehicle body 102.

Enclosure ECU 120 of vehicle system 100 can provide monitoring and control of actuators within the enclosures of vehicle body 102. In an example, ECU 120 can operate as a body control module to control locking/unlocking of the doors, trunk, and hood of vehicle body 102. Based on inputs from a user interface, ECU 120 can also control air-conditioning, heating, infotainment, interior lighting, etc. HMI ECU 130 can provide notifications to the operator of vehicle system 100, such as audio notifications (e.g., beeps or chimes) and vibratory notifications (e.g., activating a vibration actuator in a driver’s seat of vehicle body 102).

Vehicle system 100 can include a variety of additional devices and components, such as vehicle components 145, 147, and 149, which may utilize vehicle network 105 to transmit and receive data relating to vehicle speed, propulsion, location, subsystem and/or component status, etc. In an example, additional sensors of vehicle system 100 can provide data for controlling operation of a component of a set of vehicle components, such as a component for controlling an aspect of vehicle operation. Vehicle components can include transmission components, a park assist component, an adaptive cruise control component, an adaptive steering component, a movable seat, and the like. Vehicle components 145, 147, and 149 can include additional processing and control units (e.g., additional ECUs) that likewise communicate via vehicle network 105.

ECUs 110, 120, 130, and 140 can be generally programmed for communications on vehicle network 105, which may include a communications bus such as a CAN bus, LIN bus, etc., and/or other wired and/or wireless technologies (e.g., WIFI, Bluetooth®, Ultra-Wideband (UWB), etc.) Vehicle network 105 can represent one or more mechanisms by which gateway ECU 110 may communicate with a remote computer, such as server 160 via network 150. Accordingly, vehicle network 105 can include one or more of various wired or wireless communication mechanisms, including any desired combination of wired (e.g., cable and fiber) and/or wireless (e.g., cellular, wireless, satellite, microwave, and radio frequency)) communication mechanisms and any desired network topology (or topologies when multiple communication mechanisms are utilized). Exemplary communication networks include wireless communication networks (e.g., using Bluetooth®, Bluetooth® Low Energy (BLE), UWB, IEEE 802.11, etc.), vehicle-to-vehicle (V2V) such as Dedicated Short-Range Communications (DSRC), etc.), local area networks (LAN) and/or wide area networks (WAN), including the Internet, providing data communication services. In the example of FIG. 1, gateway ECU 110 can communicate with vehicle network 105 via vehicle bus interface 112. Enclosure ECU 120 can communicate with vehicle network 105 via vehicle bus interface 122. HMI ECU 130 can communicate with vehicle network 105 via bus interface 132. ADAS ECU 140 can communicate with vehicle network 105 via bus interface 142.

In the example of FIG. 1, gateway ECU 110 can communicate with ADAS ECU 140 utilizing point-to-point ethernet bus link 136 that conveys bidirectional communications between ethernet switch 114 and ethernet switch 144. Gateway ECU 110 can communicate with HMI ECU 130 utilizing point-to-point ethernet bus link 126 that conveys bidirectional communications between ethernet switch 115 and ethernet transceiver 134. In an example, ethernet switch 115 and ethernet transceiver 134 are pass-through devices in which logic functions, such as self-loops 315, 318, etc. (of FIG. 3) are executed via program instructions by gateway ECU 110, HMI ECU 130, etc. In an example, gateway ECU 110 includes a plurality of switches 115 that enable gateway ECU 110 to communicate via independent point-to-point ethernet links with various ECUs of vehicle system 100. Such independent point-to-point ethernet links can permit gateway ECU to communicate with, for example, an ethernet transceiver of a first link partner (e.g., enclosure ECU 120) while an ethernet transceiver of a second link partner (e.g., HMI ECU 130) has been transitioned to a sleep state.

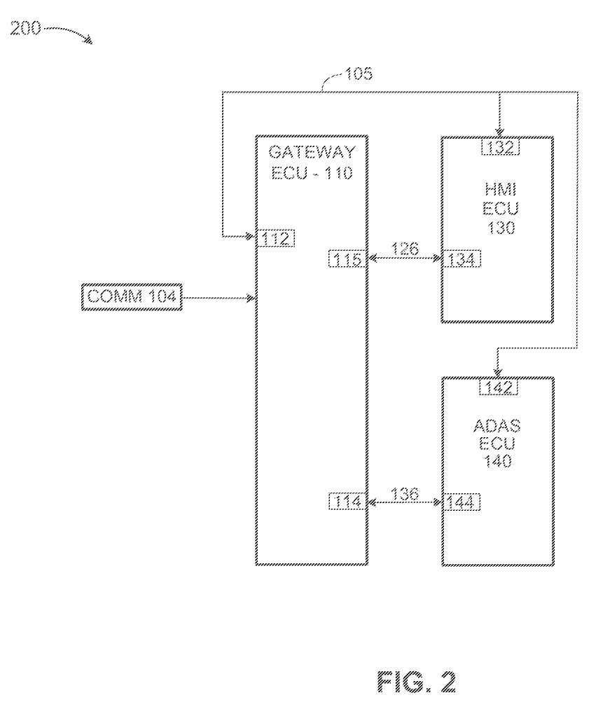

Gateway ECU 110 can communicate with enclosure ECU 120 utilizing point-to-point ethernet bus link 116 that conveys bidirectional communications between ethernet switch 118 and ethernet switch 124. Accordingly, based on gateway ECU 110 receiving wireless data from an external source, such as data transferred from server 160 and received through communications component 104. Gateway ECU 110 can communicate the received data to one or more of enclosure ECU 120, HMI ECU 130 and ADAS ECU 140. In one example, such received data can include an update to firmware, software, configuration files, user profiles stored in a memory accessible to an ECU, etc. As described in reference to FIGS. 2-4, ECU 110 may utilize point-to-point ethernet bus links 116, 126, or 136 to establish bidirectional communications between gateway ECU 110 and one or more of ECUs 120, 130, and 140.

Ethernet bus link 116 can be a primary communications bus between gateway ECU 110 and enclosure ECU 120. Ethernet bus link 126 can be a primary communications bus between ECU 110 and HMI ECU 130. Ethernet bus link 136 can be a primary communications bus between gateway ECU 110 and ADAS ECU 140. In this disclosure, a “primary” communications bus means a communications channel through which a majority of communications is to occur. Accordingly, gateway ECU 110 utilizes ethernet bus links 116, 126 and 136 in a majority of instances in response to incoming data from communications component 104. In this disclosure a “secondary” communications bus means a communications channel through which a minority of communications is to occur. In the context of FIG. 1, gateway ECU 110 utilizes vehicle network 105 as a secondary communications channel in response to a degradation, or a suspected degradation, in the ability of ethernet bus links 116, 126, or 136 to convey communications traffic between the ECUs of vehicle system 100.

In an example, ECUs 110, 120, 130, and 140 can include a generic computer with a processor and memory as described above and/or may include an embedded controller that can perform or execute a specific function or set of functions. ECUs 110, 120, 130, and 140 can include dedicated electronic circuitry including one or more application specific integrated circuits (ASICs) that are manufactured for a particular operation (e.g., an ASIC for processing sensor data and/or communicating the sensor data). In another example, ECUs 110, 120, 130, and 140 can include an FPGA (Field-Programmable Gate Array) which is an integrated circuit manufactured to be configurable by an authorized user. Typically, a hardware description language such as VHDL (Very-High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming (e.g., stored in a memory electrically connected to the FPGA circuit). In some examples, a combination of processor(s), ASIC(s), and/or FPGA circuits may be included in ECUs 110, 120, 130, and 140.

FIG. 2 shows example components 200 involved in power management of a vehicle network. As seen in FIG. 2, gateway ECU 110 can sustain bidirectional communications with HMI ECU 130 utilizing point-to-point ethernet bus link 126. Gateway ECU 110 additionally can sustain bidirectional communications with ADAS ECU 140 utilizing point-to-point ethernet bus link 136. In such an example, gateway ECU 110 can begin receiving data, which may represent a software update to, for example, HMI ECU 130 and/or ADAS ECU 140. Based on receipt of incoming data from an external source (e.g., network 150), gateway ECU 110 can trigger a wake-up signal to HMI ECU 130 and/or ADAS ECU 140. Software updates can include updates to firmware, program memory, configuration settings, updates to user profiles, etc. Accordingly gateway ECU 110 can establish an ethernet communications session with HMI ECU 130, ADAS ECU 140, or any other ECU in the system architecture of vehicle system 100 (of FIG. 1).

In an example, a software update communicated to gateway ECU 110 via communications component 104 may include relatively small changes to a user profile, for example, stored within a memory accessible to HMI ECU 130. In addition, a software update communicated from gateway ECU 110 may include a relatively complex change to ADAS ECU 140. In an example, while gateway ECU 110 is transmitting a software update to HMI ECU 130, which may occur in groups of data frames separated by periods of inactivity, gateway ECU 110 can transmit a network management message. A data frame in this context is a sequence of symbols at a physical coding sublayer of the open systems interconnect model describing seven layers of computer-based communications over a network. In an example, a data frame can include a sequence of 12 symbols, wherein a symbol includes eight bits followed by a parity bit. A network management message can be transmitted utilizing the user datagram protocol. A user datagram protocol means a protocol for a connectionless transmission that is pushed to a link partner without being followed by an acknowledgment from a receiving link partner.

Thus, in an example, although a software update transmitted from gateway ECU 110 may be provided in data frames followed by periods of inactivity on point-to-point ethernet bus link 126, gateway ECU 110 can sustain communications with HMI ECU 130 via occasional or periodic (e.g., every 200 milliseconds, every 500 milliseconds, every second, etc.) transmission of the network management message. Likewise, HMI ECU 130 can transmit a bus sustaining network management message. Accordingly, HMI ECU 130 can continue to remain in an awakened state until all data frames are transferred from gateway ECU 110 despite periods of inactivity in data transmission from gateway ECU 110.

In response to HMI ECU 130 detecting an absence of a bus traffic sustaining message from gateway ECU 110 (e.g., transmitted utilizing a network management message), HMI ECU 130 can transition to a silent mode (e.g., a receive exclusive mode), wherein HMI ECU 130 refrains from transmitting data, such as a network management message utilizing the user datagram protocol. After transitioning to a silent mode, HMI ECU 130 can initiate a timer (e.g., 2.0 seconds, 3.5 seconds, 5.0 seconds, 7.5 seconds, etc.). After expiration of the timer, HMI ECU 130 can transmit a low-power sleep (LPS) request, which can initiate a handshaking operation with gateway ECU 110. Based on gateway ECU 110 completing transmission of data (e.g., a software update, firmware update, an update to configuration settings, user profiles, or another update) gateway ECU 110 can acknowledge the low-power frame request. In response to reception of an acknowledgment of the low-power sleep request, HMI ECU 130 can transition to a sleep state. In an example, based on an absence of acknowledgment of a low-power sleep request from gateway ECU 110, HMI ECU 130 can receive a command from a secondary communications bus (e.g., vehicle network 105), which can compel HMI ECU 130 to enter a sleep state.

In the example of FIG. 2, in addition to transmitting a software update to HMI ECU 130, gateway ECU 110 can transmit a software update to ADAS ECU 140. A software update to ADAS ECU 140 may include an update that is of greater complexity (e.g., a larger number of data frames transmitted to ADAS ECU 140, a larger number of queries to or from ADAS ECU 140, etc.) in relation to a software update to HMI ECU 130. Accordingly, after HMI ECU 130 has transitioned to a sleep state, ADAS ECU 140 can continue to receive data frames transmitted from gateway ECU 110.

FIG. 3 shows an example message flow diagram 300 among an ECU of a vehicle system. In the example of FIG. 3, gateway ECU 110 can receive incoming data 303 from an external source, such as data transferred from server 160 via network 150 and communications component 104. In response to receipt of data at gateway ECU 110, which may include a software update to an ECU (e.g., enclosure ECU 120, HMI ECU 130, ADAS ECU 140, etc.), gateway ECU 110 can trigger wake-up request 306, which activates a serial peripheral interface to provide output data to ethernet switch 115. Based on receipt of wake-up request 306, triggered in response to incoming data, ethernet switch 115 can generate a targeted wake-up request message 309 for transmission on point-to-point ethernet bus link 126. In an example, wake-up request 306 can comply with a TC10 standard wake-up pulse, which means a pulse having a duration of between 10 microseconds and one millisecond and a current of between five microamperes and 50 microamperes. In an example, a TC10 pulse can be about 40 milliseconds. A TC10 wake-up pulse can be transmitted using a dedicated input/output pin or may be transmitted utilizing another pin of point-to-point ethernet bus link 126.

In the example of FIG. 3, ethernet switch 115 executes self-loop 318, which generates feedback to verify that wake-up request message 309 has been transmitted along point-to-point ethernet bus link 126. In an example, self-loop 318 includes gateway ECU 110 reading the previously transmitted message (e.g., wake-up request message 309), so as to verify transmission of the wake-up message. Similarly, ethernet transceiver 134 executes self-loop 315, which verifies transmission of wake-up input 312 from ethernet transceiver 134 to HMI ECU 130. As seen in FIG. 3, based on a TC10 wake-up pulse being unable to transition point-to-point ethernet bus link 126 to an active state, gateway ECU 110 can utilize vehicle network 105 to transition bus link 126 to the active state (e.g., wake-up signal 384).

In the example of FIG. 3, gateway ECU 110 may receive an update for transmission to HMI ECU 130, wherein the update includes a small number of data frames (e.g., 25 data frames, 50 data frames, 100 data frames, etc.). Data frames (e.g., TX traffic 327) transmitted from gateway ECU 110 along ethernet bus link 126 (e.g., included in RX/TX traffic 324) can be interspersed with periods of inactivity in receive/transmit data frames. (“TX” is shorthand for “transmit” and “RX” is shorthand for “received.”) Accordingly, during such periods of inactivity, HMI ECU 130 can transmit a bus sustaining message, which maintains activity on ethernet bus link 126. In an example, a bus sustaining message includes a network management message sent utilizing the user datagram protocol (NM UDP 332). A bus sustaining message can be transmitted from gateway ECU 110 (NM UDP 321). At other times, such as while ethernet transceiver 134 is actively receiving data frames from ethernet switch 115, HMI ECU 130 can transmit message traffic (TX traffic 330) along ethernet bus link 126, which can include acknowledgments, a request for retransmission of a lost, corrupted, or missed data frame, etc. In an example, bus sustaining messages can be transmitted at intervals such as every 250 milliseconds, every 500 milliseconds, every 750 milliseconds, etc.

In the example of FIG. 3, based on an absence of bus sustaining messages (e.g., NM UDP 321), HMI ECU 130 may determine that no more data frames are to be transmitted from gateway ECU 110. HMI ECU 130 may then enter a transition from an active state to a sleep state via sleep request 333. In addition, based on an absence of bus sustaining messages from ethernet switch 115, HMI ECU 130 can initiate a timer (e.g., timer 336), which begins a phased transition from an active state to a sleep state. In an example, ECU 130 can implement a 2.5 second timer, a 3.0 second timer, a 3.5 second timer etc., or a longer timer such as a 7.0 second timer, a 7.5 second timer, etc. After beginning the timer, HMI ECU 130 can initiate the transition from the active to the sleep state by first transitioning to a silent mode, during which HMI ECU 130 refrains from initiating TX traffic 330. After expiration of the timer, HMI ECU 130 can continue with the transition from the active state to the sleep state by transmitting sleep request 342 and stopping any transmission (stop TX 339) of scheduled acknowledgments, bus-sustaining messages, etc., Based on receipt of sleep request 342, ethernet transceiver 134 can transmit low-power sleep request 345, which informs gateway ECU 110 that HMI ECU 130 has transitioned from an active state to a sleep state. Based on gateway ECU 110 having no more data frames to transmit to HMI ECU 130, gateway ECU 110 can transmit sleep request 348 to ethernet switch 115.

In the example of FIG. 3, receipt of low-power sleep request 345 and low-power sleep request acknowledgment 351 is part of a handshaking process in which HMI ECU 130 requests permission from gateway ECU 110 to transition from an active state to a sleep state. As seen in FIG. 3, ethernet transceiver 134 implements link shut down and ethernet transceiver sleep (LSETS) 357. LSETS 357 can be a process that transitions ethernet transceiver 134 to a sleep state. Based on ethernet transceiver 134 transitioning to a sleep state, communications utilizing ethernet bus link 126 HMI can be inactivated while other processes of HMI ECU 130, such as displaying visual, audio, or vibratory notifications to an operator of vehicle system 100, can continue. Similarly, ethernet switch 115 implements link shut down and ethernet transceiver sleep (LSETS) 354. LSETS 354 can be a process that transitions switch 115 to a sleep state. Based on LSETS 354 transitioning to a sleep state, communications utilizing ethernet bus link 126 HMI can be inactivated while other processes of gateway ECU 130, such as communicating with enclosure ECU 120 via ethernet bus link 116, communicating with vehicle network 105, etc., can continue.

In an example, based on ethernet switch 115 being unable to detect low-power sleep request 345, or determining that continued receive/transmit traffic 324 is present on ethernet bus link 126, gateway ECU 110 can (e.g., alternatively) utilize vehicle network 105 to direct HMI ECU 130 to transition from an active state to a sleep state. In an example, gateway ECU 110 can set a diagnostic trouble code (DTC) to indicate degradation in bus communications utilizing ethernet bus link 126. Such degradations can include an open circuit, a short circuit, bus ringing resulting from an impedance mismatch between source and load, etc. Based on receipt of a directed sleep message (TX sleep command 360) from gateway ECU 110 (e.g., RX sleep command 363) HMI ECU 130 can complete the transition from the active state to the sleep state. In an example, HMI ECU 130 can transmit two or more low-power sleep requests (e.g., retries) without receiving low-power sleep request acknowledge 351 prior to HMI ECU 130 setting a DTC.

In the example of FIG. 3, HMI ECU 130 initiates a wake-up request (e.g., wake up request 375) similar to wake-up request 306 initiated by gateway ECU 110. In an example, wake-up request 375 can be triggered in response to receiving a key operation from a user interface at vehicle body 102, such as a user inserting a key into the ignition of vehicle system 100, a user inserting a key into a door or trunk of vehicle body 102, etc., HMI ECU 130 can transition from the sleep state to an active state. In such an example, ethernet transceiver 134 transmits wake-up message 378 to ethernet switch 115. Based on receipt of wake-up message 378, ethernet switch 115 can generate wake-up input 381, which transitions gateway ECU 110 from a sleep state to an active state. In another example, HMI ECU 130, or any other ECU of vehicle system 100, can determine that analytics (e.g., analytical data from one or more components of vehicle system 100) are to be uploaded from gateway ECU 110 to server 160, such as via communications component 104. Such analytics can include engine diagnostics, braking pad wear, diagnostic trouble codes, digitized output signals from engine torque sensors, etc. In an example, wake up request 375 transmitted from HMI ECU 130 to ethernet transceiver 134 can be followed by ECU wake 372 self-loop, which verifies that wake-up request 375 has been transmitted from HMI ECU 130 to ethernet transceiver 134.

Accordingly, in an example, a wake-up request can be transmitted from (or originated by) gateway ECU 110, HMI ECU 130, or another ECU of vehicle system 100. An originating or transmitting ECU can transmit bus sustaining network management messages (e.g., NM UDP 321, 332) over ethernet bus link 126. A low-power sleep request can be transmitted or originated by gateway ECU 110, HMI ECU 130, or another ECU of vehicle system 100 after bus-sustaining network management messages are inactivated by both ECUs communicating via ethernet bus link 126.

Although the example of FIG. 3 refers to gateway ECU 110 and HMI ECU 130, HMI ECU 130 can be replaced by enclosure ECU 120, ADAS ECU 140, or any other suitable ECU of vehicle system 100. In such examples, operations between gateway ECU 110 and enclosure ECU 120, ADAS ECU 140, or another ECU of vehicle system 100 can occur similar to the operations described between gateway ECU 110 and HMI ECU 130.

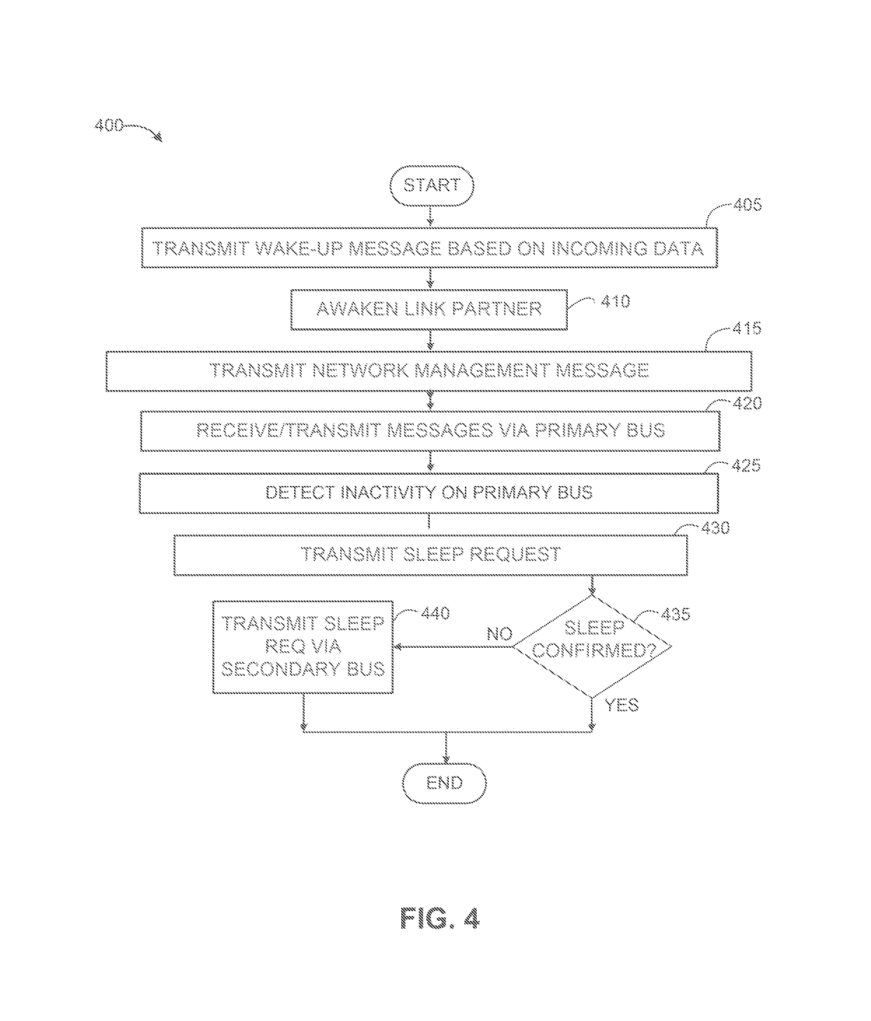

FIG. 4 is a diagram of an example process 400 for network power management. In the example of FIG. 4, an ECU (e.g., gateway ECU 110, enclosure ECU 120, HMI ECU 130, etc.) may receive wake-up request message 309, which transitions a receiving ECU from a sleep state to an active state. During periods of inactivity of ethernet bus link 126 one or more of gateway ECU 110, enclosure ECU 120, or another ECU can transmit a bus sustaining network management message (NM UDP 321, 332), which maintains ethernet bus link (e.g., 126) in an active state. In response to an absence of a bus sustaining message, an ECU (120, 130, 140, etc.) can begin a transition from an active state to a sleep state by entering a silent mode, in which messages from ethernet bus link 126 can be received without generating a response from a targeted ECU. After expiration of a period of time (e.g., 3.0 seconds, 3.5 seconds, 4.0 seconds, etc.) during which bus sustaining messages are not received, a target ECU can continue the transition from an active state to a sleep state. Based on a handshaking operation involving low-power sleep request 345 and low-power sleep request acknowledge 351 a target ECU can complete a transition from an active state to a sleep state. Based on an absence of, for example, low-power sleep request acknowledge 351, which may be detected during a self-loop process at ethernet switch 115 an ECU can generate a sleep command utilizing vehicle network 105, which may be a CAN bus, a LIN bus or other vehicle bus structure. An ECU may then generate a diagnostic trouble code, which may indicate loss of communications via ethernet bus link 126. In an example, an ECU may generate a diagnostic trouble code to indicate continued activity on ethernet bus link 126 indicating that low-power sleep request 345 has not been received at a target ECU.

Process 400 can begin at block 405, which includes transmitting, such as via ethernet switch 115 of gateway ECU 110, a wake-up message triggered in response to incoming data 303. In an example, incoming data 303 can include incoming data generated by an update manager at an external source. In another example, incoming data 303 can include data that is based on a key operation, such as a user inserting a key to unlock an enclosure (e.g., a trunk, a door, an ignition switch, etc.) of vehicle body 102. In another example, incoming data 303 can include data triggered by an analytics component (e.g., analytics based on engine performance, vehicle braking, powertrain analytics, etc.).

Process 400 can continue at block 410, in which an ECU awakens a link partner. For example, an ECU can transmit a wake-up message, which may conform to a TC10 wake-up pulse, having a duration of between 10 microseconds and one millisecond and a current of between five microamperes and 50 microamperes. In an example, a TC10 pulse can have a duration of about 40 milliseconds. A TC10 wake-up pulse can be transmitted using a dedicated input/output pin or may be transmitted utilizing another pin of point-to-point ethernet bus link 126.

Process 400 can continue at block 415, which can include an ECU transmitting a network management message such as using the user datagram protocol. In an example, an ECU can transmit a network management message at intervals of 250 milliseconds, 500 milliseconds, 750 milliseconds, etc. In an example, a network management message can be a bus sustaining message which maintains an ethernet bus in an active state while data frames are not being exchanged between a target ECU and a link partner ECU.

Process 400 can continue at block 420, during which messages (receive/transmit) can be exchanged via a primary bus, which can include ethernet bus link 126. Block 420 can include exchange of data frames that update ECU software, firmware, etc. Block 420 can include data frames that include analytics, updates to user profiles, configuration settings etc.

Process 400 can continue at block 425, which includes an ECU detecting inactivity on a primary bus, such as ethernet bus link 126. Detection of inactivity can include detecting an absence of a bus sustaining message, such as a network management message utilizing the user datagram protocol. Block 425 can include an ECU setting a 3.0 second timer, a 3.5 second timer, a 4.0 second timer, etc.) during which an ECU transitions to a silent mode. While operating in the silent mode, an ECU can receive data but refrains from engaging in transmit operations.

Process 400 can continue at block 430, in which, based on expiration of a timer set at block 425, and ECU can transmit low-power sleep request 345. Block 430 can include an ECU receiving low-power sleep request acknowledge 351, which can be a handshaking operation between, for example, HMI ECU 130 and gateway ECU 110.

Process 400 can continue at block 435, which can include a confirmation of a handshaking operation between, for example, HMI ECU 130 and gateway ECU 110. For example, based on completion of a handshaking operation, which includes transmission of low-power sleep request 345 and low-power sleep request acknowledgment 351, HMI ECU 130 can complete a transition from an active state to a sleep state. Block 435 can include an ethernet bus switch performing a self-loop operation (e.g., LSETS 354, LSETS 357) to transition an ethernet transceiver to a sleep state. Based on an ethernet transceiver being placed in a sleep state, an ECU, such as enclosure ECU 120, can continue to execute other processes such as processes based on a user inserting a key into a door or trunk of vehicle body 102, can remain active

After completion of a successful handshaking operation, process 400 ends.

At block 440, based on an absence of confirmation of a low-power sleep request, such as an absence of low-power sleep request acknowledge 351, gateway ECU 110, for example, can direct an ECU to enter a sleep state. In accordance with FIG. 3, gateway ECU 110 can transmit sleep command 360 via vehicle network 105, which can direct HMI ECU 130 to complete a transition from an active state to a sleep state. Block 440 can include gateway ECU 110 setting a diagnostic trouble code to indicate degradation of ethernet bus link 126.

The descriptions of the various examples and implementations have been presented for purposes of illustration but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical enhancements over technologies found in the marketplace, or to enable others of ordinary skill in the art to understand the implementations disclosed herein.

As will be appreciated, the methods and systems described may be implemented as a computer program product. The computer program product may include a computer readable storage medium (or media) having computer readable program instructions thereon for causing a processor to carry out operations discussed herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry.

Various implementations are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

All terms used in the claims are intended to be given their plain and ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary. Use of “in response to” and “upon determining” indicates a causal relationship, not merely a temporal relationship.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A system comprising:
a computer including a processor coupled to a memory, the memory storing instructions executable by the processor to:
transmit a wake-up signal to a primary communications bus based on incoming data from an external source;
initiate a timer based on an absence of a bus traffic sustaining message; and
select a linked computer for a phased transition to a sleep state based on expiration of the timer, wherein the phased transition to the sleep state includes a silent mode prior the transition to the sleep state.

2. The system of claim 1, wherein the wake-up signal is triggered in response to incoming data generated by an update manager at the external source.

3. The system of claim 1, wherein the wake-up signal is triggered in response to a key operation received from a user interface of a vehicle.

4. The system of claim 1, wherein the wake-up signal is triggered by an analytics component within a vehicle.

5. The system of claim 1, wherein the bus traffic sustaining message includes a user datagram protocol network management message.

6. The system of claim 1, wherein the instructions to initiate the phased transition to the sleep state of the computer include instructions to transmit a low-power sleep command to the linked computer that includes an interface to the primary communications bus.

7. The system of claim 1, wherein the wake-up signal is a TC10 wake-up pulse and wherein the primary communications bus is an ethernet bus.

8. The system of claim 1, wherein the instructions further include instructions to:
detect continued activity of the primary communications bus after initiation of the phased transition to the sleep state; and
transmit, via a secondary communications bus, a sleep command to the linked computer.

9. The system of claim 8, wherein the secondary communications bus is a controller area network bus.

10. The system of claim 8, wherein the instructions further include instructions to generate a diagnostic trouble code (DTC) based on the continued activity of the primary communications bus.

11. The system of claim 1, wherein the phased transition to the sleep state of the linked computer includes a handshake operation wherein the linked computer and the computer exchange low-power sleep permissions and wherein the instructions further include instructions to:
transmit a second wake-up signal from the computer during the handshake operation.

12. A method comprising:
transmitting, at a first computer having an interface to a primary communications bus, a wake-up signal based on incoming data from an external source;
initiating a timer based on an absence of a bus traffic sustaining message; and
selecting a linked computer for a phased transition to a sleep state based on expiration of the timer, wherein the phased transition to the sleep state includes a silent mode prior to the sleep state.

13. The method of claim 12, wherein the wake-up signal is triggered in response to incoming data generated by an update manager at the external source.

14. The method of claim 12, wherein the wake-up signal is triggered in response to a key operation received from a user interface of a vehicle.

15. The method of claim 12, wherein the wake-up signal is triggered by an analytics component within a vehicle.

16. The method of claim 12, wherein the bus traffic sustaining message includes a user datagram protocol network management message.

17. The method of claim 12, wherein initiating the phased transition additionally comprises:
transmitting a low-power sleep command from the first computer to a second computer via the primary communications bus.

18. The method of claim 12, wherein the wake-up signal is a TC10 wake-up pulse and wherein the primary communications bus is an ethernet bus.

19. The method of claim 12, further comprising:
detecting continued activity of the primary communications bus after initiation of the phased transition; and
transmitting, via a secondary communications bus, a command to inactivate the primary communications bus.

20. The method of claim 12, further comprising:
generating a diagnostic trouble code (DTC) based on continued activity of the primary communications bus after transmitting a low-power sleep command to the linked computer.
